(19) United States
(12) Patent Application Publication
(10) Pub. No.: US 2010/0180797 A1
(43) Pub. Date: Jul. 22, 2010

(54) Ceramic Fire Protection Panel and Method for Producing the Same

(76) Inventor: Horst Puckelwaldt, Berlin (DE)

Correspondence Address: ROTHWELL, FIGG, ERNST & MANBECK, P.C., 1425 K STREET, N.W., SUITE 800, WASHINGTON, DC, 20005, US

(21) Appl. No.: 12/664,736

(22) PCT Filed: Jun. 13, 2008
(86) PCT No.: PCT/EP2008/004785

§ 371 Date: Dec. 15, 2009

(30) Foreign Application Priority Data
Jun. 15, 2007 (DE) 10 2007 027 653.4

(51) Int. Cl. C09D 197/02

(52) U.S. Cl. 106/164.4

(57) ABSTRACT

The present invention relates to a heat-resistant material based on calcium hydrosilicate, a process for producing it and the use of the material as fire protection material or insulation material.

The present invention relates to a heat-resistant material based on calcium hydrosilicate, a process for producing it and the use of the material as fire protection material or insulation material.

The use of materials based on calcium hydrosilicate for thermal insulation and as fire protection material is already known in the prior art. Thus, the European patent EP 0 220 219 describes a calcium hydrosilicate material which has essentially a fibrous tobermorite structure. The material can be obtained by a hydrothermal process from a composition containing slaked lime and SiO₂ in a ratio of from 0.73 to 0.76% by weight and also inorganic or organic fibres. However, a disadvantage of the material described in EP 0 220 219 is its relatively low mechanical strength. The compressive strength is from about 1.4 to 1.9 MPa and the flexural strength is at most 0.98 MPa.

The high demands made of the mechanical strength of building materials made further development of the material necessary. To obtain a heat-resistant material based on calcium hydrosilicate tobermorite and having improved strength, a mixture having an altered composition in which hydrated lime and quartz powder are present in a CaO:SiO₂ ratio of from 0.60 to 0.735% by weight was used for production of the material in EP 0 404 196. The material produced therefrom has a flexural strength of 0.91 MPa and a compressive strength at room temperature of 1.6 MPa.

However, the materials of the prior art are still unsatisfactory in terms of their building properties; in particular, the strength of the fire protection materials described decreases greatly on prolonged exposure to heat.

It was therefore an object of the present invention to provide, proceeding from the known materials, a heat-resistant material having improved heat resistance and improved building properties.

With regard to this object, it has now been found that a heat-resistant material having excellent mechanical properties can be obtained when a mixture which contains sodium silicate in addition to the components described in the prior art is used as starting material.

According to a first aspect, the invention provides a process for producing a heat-resistant material, which comprises the steps:
i) provision of an aqueous mixture containing an alkali metal salt of carboxymethylcellulose, SiO₂, Ca(OH)₂, sodium silicate and organic fibres;
ii) heating of the mixture at a temperature of from 190 to 200° C. for from 14 to 28 hours at a pressure of saturated steam of from 11 to 13 bar;
iii) drying of the material obtained in ii) at a temperature of not more than 250° C.

The material produced in this way essentially has a coral-like tobermorite structure. According to the invention, it has been found that the addition of sodium silicate to the mixture in step i) promotes the formation of the tobermorite structure. The water-soluble sodium silicate reacts with calcium hydroxide to form water-insoluble calcium silicate which covers the surface of the organic fibres. In the subsequent hydrothermal treatment in step ii), the calcium silicate formed in this way functions as crystallization nucleus for the further formation of calcium hydrosilicate. A particularly regular, coral-like tobermorite structure is formed. This structure has a high pore volume and at the same time a surprisingly high strength.

The amounts of Ca(OH)₂ and SiO₂ used are preferably selected so that they correspond to a weight ratio of CaO to SiO₂ of from about 0.3 to 3, preferably from 0.5 to 2 or from 0.5 to 1.3. For example, the ratio can be from about 0.65 to 0.75. SiO₂ can, for example, be added in the form of silica sand. The silica sand can be milled to a desired particle size distribution before use.

Sodium silicate can be added in an amount of about 0.1-5% by weight, preferably 0.1-1% by weight, based on the total amount of solid constituents.

The alkali metal salt of carboxymethylcellulose is preferably used in an amount of from 0.1 to 5% by weight, preferably from 0.1 to 1% by weight, preferably from about 0.3 to 0.8% by weight, based on the total amount of all solid constituents. Particular preference is given to using sodium carboxymethylcellulose.

The aqueous mixture in step i) additionally contains organic fibres such as cellulose fibres and/or wood fibres. A suitable amount of fibres is, for example, from about 2.5 to 7.5% by weight, based on the total amount of all solid constituents, preferably 3.5-5.5% by weight. The organic fibres can, for example, be added in the form of an aqueous suspension.

The proportion of water in the starting mixture is preferably at least 20%, more preferably at least 40%, 50% or 75%, based on the total composition.

In the process of the invention, the provision of the aqueous mixture in step i) is preferably effected by
a) providing a mixture of SiO₂ and water,
b) adding Ca(OH)₂, sodium silicate, an aqueous solution of an alkali metal salt of carboxymethyl-cellulose and an aqueous suspension of organic fibres and
c) mixing the components to give a homogeneous mixture.

Proceeding from the aqueous mixture obtained in step i), a hydrothermal process is carried out in step ii). The aqueous mixture is heated at a temperature of from about 160 to 250° C., preferably from 180 to 220° C., more preferably from 190 to 200° C., for from 10 to 28 hours, preferably from 14 to 24 hours, e.g. from 16 to 20 hours. This heating is carried out at a pressure of saturated steam of from about 11 to 13 bar, preferably from about 11.5 to 12.5 bar. To carry out the hydrothermal process in step ii), the aqueous mixture can be poured into a mould and then heated under steam pressure, e.g. in an autoclave. The mould used can be selected so as to correspond to the intended use of the future heat-resistant material.

After the hydrothermal treatment, the product obtained is, if appropriate, removed from the mould and subsequently dried in step ii). Drying is carried out at a temperature of up to 300° C., for example from 170 to 250° C., preferably from about 180 to 200° C.

The above-described process gives a calcium hydrosilicate material which has an essentially tobermorite structure and in which the crystal structure has improved cohesion compared to the materials of EP 0 220 219 or EP 0 404 196. The mechanical properties such as compressive strength and flexural strength of the material are significantly better than those of materials of the prior art and the material retains its mechanical strength even after prolonged exposure to heat. Compared to the materials from EP 0 220 219 or EP 0 404 196, which are produced without sodium silicate, the compressive strength and flexural strength are approximately doubled.

To modify the properties of the heat-resistant material, it is possible to add further constituents.

According to the invention, it has been found that the addition of cement to the starting mixture in step i) brings about significantly improved cohesion of the individual components. Cement functions as binder and leads to a calcium hydrosilicate material having a still further improved compressive strength and flexural strength.

In chemical terms, cement comprises from about 58 to 66% of calcium oxide (CaO), from 18 to 26% of silicon dioxide (SiO₂), from 4 to 10% of aluminium oxide (Al₂O₃) and from 2 to 5% of iron oxide (Fe₂O₃). These main constituents are present in the cement predominantly in the form of tricalcium silicate (3 CaO×SiO₂), dicalcium silicate (2 CaO×SiO₂), tricalcium aluminate (3 CaO×Al₂O₃) and tetracalcium aluminate ferrite (4 CaO×Al₂O₃×Fe₂O₃). Apart from the chemical and mineralogical composition, the fineness of the cement also has an effect on its properties. For the purposes of the present invention, it is possible to use any cement, for example portland cement, portland composite cement, slag cement, pozzolanic cement or composite cement. Preference is given, according to the present invention, to using portland cement.

In a preferred embodiment, the aqueous mixture in step i) contains cement in an amount of preferably from 0.01 to 10% by weight, based on the total amount of all solid constituents. The amount of cement is particularly preferably from 0.01 to 5% by weight, based on the total amount of all solid constituents.

In addition, it has been found, according to the invention, that the heat resistance of the calcium hydrosilicate material can be improved further by additionally adding one or more salts such as sodium or magnesium salts to the starting mixture. Magnesium chloride has been found to be particularly useful here because of its high boiling point of about 1412° C. However, it is also possible to use other salts such as magnesium silicate or magnesium carbonate.

The salt is preferably used in an amount of from 0.1 to 10% by weight, preferably from 0.5 to 8% by weight or from 0.1 to 5% by weight, based on the total amount of solid constituents. As a result of the presence of the salt, a significantly larger amount of water can be stored in the calcium hydrosilicate material. It is assumed that the salt occupies voids in the tobermorite crystal and water is incorporated into the lattice structure as a result.

In addition, it is possible to add Na(OH), preferably in an amount of from 0.01 to 0.03% by weight, based on the total amount of Ca(OH)₂ and SiO₂.

The material of the invention contains a relatively high proportion of water. When the material is used as fire protection material, the amount of water is critical since this is gradually given off as a result of heating in the case of fire. If the water is increasingly removed from the crystal structure, the stability of the material gradually decreases and it finally disintegrates. In the case of the material of the invention, water is enclosed in the tobermorite structure and cannot escape even on heating.

The material of the invention has a high stability at high temperatures and is heat resistant up to 1100° C. It meets the strictest regulations for fire protection materials which are used in dwellings, public buildings and public transport. In this context, the improved resistance of the material to large temperature differences is also advantageous. In a cooling test, the material is stable even when the material heated to 1100° C. is cooled in cold water (20° C.)

In addition, the material has universal insulation properties and can therefore serve, for example, as shielding against electromagnetic radiation, heat or sound. The electrical resistance of the material of the invention at a material thickness of 0.5 mm is preferably at least about 15 MΩ, particularly preferably at least about 20 MΩ. At a thickness of 10 mm, the electrical resistance is preferably at least about 150 000 MΩ, particularly preferably at least about 200 000 MΩ.

The material also has a very good mechanical strength and shock resistance. At room temperature, the compressive strength of the material at 5% deformation is, in a preferred embodiment, at least 8.0 MPa, preferably at least 8.4 MPa, and the compressive strength to maximum destruction is preferably at least 10.0 MPa. The flexural strength of the material of the invention is significantly greater than that of the known fire protection materials of the prior art. The flexural strength at room temperature is preferably at least 3.5 MPa, particularly preferably at least 3.9 MPa.

The screw bearing capability of the material of the invention is, in a preferred embodiment, at least 0.4 kN at room temperature, particularly preferably at least 0.47 kN or at least 0.48 kN.

The material of the invention is extremely resistant to deformation. At room temperature, the modulus of elasticity is, in a preferred embodiment, at least about 1.4 GPa, preferably at least 1.5 GPa or at least 1.6 GPa. The material retains its shape even after prolonged heating.

The thermal conductivity of the material is extremely low. Even after thermal treatment at 900° C. (heating at 900° C. for 1 hour), the thermal conductivity is preferably less than 0.2 W/K, particularly preferably less than about 0.12 W/K.

The material of the invention is noncombustible and resistant to direct contact with hot gases or molten metals. It is resistant to acids and water.

Owing to the above-described advantageous physical properties of the material of the invention, it has numerous possible industrial applications. It can be used, for example, as fire protection material in buildings, underground constructions, ships, aircraft, rail vehicles and road vehicles, in the chemical industry and the metal industry. In addition, owing to its insulating properties, it can also be used for insulation against heat, vibrations, sound or electro-magnetic radiation.

The form in which the material of the invention is used can vary in any desired way depending on the intended use. For example, it can be applied in the form of boards as fire protection to parts of buildings. For this purpose, the material can also be configured as a block which can then be cut to the desired shape, e.g. boards, directly at the respective place of use, e.g. on the building site.

As an alternative, the material can also be applied as a coating to a construction element. In a further aspect, the invention provides a process for applying a heat-resistant coating, characterized in that an above-described material in a particulate state is used and is applied as a mixture with water and adhesive paste to a structure to be coated.

A suitable adhesive paste for this purpose is, for example, a sodium salt of carboxymethylcellulose, e.g. sodium carboxymethylcellulose. This can, if appropriate, be used in combination with a water-soluble alkali metal silicate such as water glass.

As particulate material, it is possible to use a material obtained by the above-described process in the form of granules or powder. It is also possible to employ used materials in the comminuted form, so that the materials of the invention can be recycled. For example, (used) fire protection boards made of the material of the invention can be comminuted and mixed with water and adhesive paste as described. It is also possible to use the dust obtained on cutting of the material to form boards for this purpose.

The application of the aqueous mixture to the structure to be coated is effected by means of any process. For example, the material can be applied by a spray process or a painting process. It is thus possible to provide, for example, a construction element such as a steel or concrete bearer, pipes, conduits or ventilation channels with a coating according to the invention.

After application, the coating is preferably dried in air.

The present invention is illustrated by the following example.

### EXAMPLE

A heat-resistant material was obtained by firstly mixing
270.00 kg of sand slurry (milled silica sand in water)
244.00 kg of lime
   3.20 kg of carboxymethylcellulose (in water)
   38.60 kg of cellulose fibres (in water)
   1.20 kg of magnesium chloride
   3.00 kg of sodium silicate and
   40 kg of portland cement
      with water (total of 384.00 kg of water). The aqueous mixture obtained in this way was then heated at a temperature of about 200° C. for 20 hours at a pressure of saturated steam of about 12 bar. The material obtained was subsequently dried in air at a temperature of about 180° C.

The material produced in this way was then subjected to various tests to examine its suitability as fire protection material and the building properties. The results are shown in the following tables.

Thermal conductivity after thermal treatment at 900° C.:

| Temperature in ° C. | | | |
|---|---|---|---|
| on the hot | on the cold | | Thermal conductivity |
| side | side | mean | (W/mK) |
| 201 | 27 | 114 | 0.118 |
| 400 | 41 | 220 | 0.118 |
| 800 | 91 | 448 | 0.166 |

Specific Heat

| Mean temperature (° C.) | 65 | 209 | 320 | 427 | 483 |
|---|---|---|---|---|---|
| Specific heat J/kg K | 721 | 771 | 866 | 894 | 928 |

Compressive Strength

| | at 5% | up to max. |
|---|---|---|
| T ° C. | deformation, MPa | destruction, MPa |
| At room temperature | 3.28 | 4.30 |
| At above 900° C. | 2.42 | 4.57 |

Flexural Strength

| Temperatures ° C. | MPa | Psi |
|---|---|---|
| At room temperature | 1.48 | 215 |
| After 900° C. | 0.61 | 88 |

Screw Bearing Capability

| Temperatures ° C. | Max. loading (kg) | Max. loading (kN) |
|---|---|---|
| At room temperature | 32.7 | 0.32 |
| After 900° C. | 30.4 | 0.30 |

Thermal Shock Resistance

The material which had been heated at 1100° C. “survived” a cooling test in cold water.

Determination of the Thermal Shock Resistance Parameter Rst

Rst parameter values of 44.80° C/m² were obtained for a material which had been treated at 900° C.

Electrical Resistance

| Plate thickness in mm | MΩ |
|---|---|
| 0.5 mm | 20 |
| 10 mm | 200 000 |

Modulus of Elasticity

| Temperature ° C. | GPa | Psi |
|---|---|---|
| Room temperature | 1.57 | 227 650 |
| At above 900° C. | 0.74 | 107 300 |

Shrinkage after Heating for 24 Hours

| | Shrinkage in % | | |
|---|---|---|---|
| Temperature ° C. | by length | by width | by thickness |
| 600 | 1.40 | 1.97 | 0.94 |
| 800 | 3.43 | 2.89 | 2.55 |

Total open porosity 80%

It can thus be seen that the material obtained according to the invention is highly suitable as fire protection material and has an excellent mechanical strength.

1. Process for producing a heat-resistant material, which comprises the steps:
i) provision of an aqueous mixture containing an alkali metal salt of carboxymethylcellulose, SiO₂, Ca(OH) ₂, sodium silicate and organic fibers;
ii) heating of the mixture at a temperature of from 160 to 250° C., preferably from 180 to 220° C., for from 10 to 28 hours, preferably from 14 to 24 hours, at a pressure of saturated steam of from 11 to 13 bar;
iii) drying of the material obtained in ii) at a temperature of not more than 300° C., preferably from 180 to 200° C.

2. Process according to claim 1, wherein step i) comprises the following steps:
a) provision of a mixture of SiO₂ and water,
b) addition of Ca(OH)₂, sodium silicate, an aqueous solution of an alkali metal salt of carboxymethylcellulose and an aqueous suspension of organic fibers and
c) mixing of the components to give a homogeneous mixture.

3. Process according to claim 1, wherein
Ca(OH)₂ and SiO₂ are added in amounts corresponding to a ratio of CaO:SiO₂ of from 0.3 to 3, preferably from 0.5 to 1.3, more preferably from about 0.65 to 0.75;
sodium silicate is added in an amount of from 0.1 to 5% by weight, preferably from 0.1 to 1% by weight, based on the total amount of solid constituents;
the mixture contains from 0.1 to 5% by weight, preferably from 0.1 to 1% by weight, more preferably from about 0.3 to 0.8% by weight, of an alkali metal salt of carboxymethylcellulose, based on the total amount of all solid constituents;
the organic fibers are added in an amount of from 2.5 to 7.5% by weight, preferably from about 3.5 to 5.5% by weight, based on the total amount of all solid constituents.

4. Process according to claim 1, wherein the organic fibers are cellulose fibers and/or wood fibers.

5. Process according to claim 1, wherein cement is additionally added to the mixture of step i), preferably in an amount of from 0.01 to 10% by weight, preferably from 0.01 to 5% by weight, more preferably from 0.1 to 1% by weight, based on the total amount of all solid constituents.

6. Process according to claim 1, wherein one or more salts such as NaCl, MgCl₂ and/or MgCO₃ are additionally added to the mixture of step i), preferably in an amount of from 0.1 to 10% by weight, preferably from 0.5 to 8% by weight of from 0.1 to 5% by weight, based on the total amount of all solid constituents.

7. Process according to claim 1, wherein NaOH is additionally added, preferably in an amount of from 0.01 to 0.3% by weight, based on the total amount of all solid constituents.

8. Process according to claim 1, wherein sodium carboxymethylcellulose is used in step i).

9. Heat-resistant material which is based on calcium hydrosilicate and can be obtained by a process according to claim 1.

10. Material according to claim 9, characterized in that it essentially has a tobermorite structure.

11. Material according to claim 9, characterized in that at room temperature it has a compressive strength at 5% deformation of at least 8.0 MPa, preferably at least 8.4 MPa, and the compressive strength to maximum destruction is at least 10.0 MPa.

12. Material according to claim 9, characterized in that at room temperature it has a flexural strength of at least 3.5 MPa, preferably at least 3.9 MPa.

13. Material according to claim 9, characterized in that it is present in the form of a coating, as a block, boards, granules or in powder form.

14. Process for applying a heat-resistant coating, characterized in that a material according to claim 9 in a particulate state is mixed with water and adhesive paste and applied to a structure to be coated.

15. Process according to claim 14, characterized in that sodium carboxymethylcellulose, if appropriate in combination with a water-soluble alkali metal silicate, is used as adhesive paste.

16. Process according to claim 14, characterized in that the material is sprayed or painted onto a construction element such as a steel or concrete bearer, pipes, conduits or ventilation channels, etc.

17. Use of a material according to claim 9 as fire protection material and/or for insulation against heat, sound, vibrations or electromagnetic radiation.
